(19) United States
(12) Patent Application Publication
(10) Pub. No.: US 2006/0064702 A1
(43) Pub. Date: Mar. 23, 2006

(54) Apparatus for tilt correction of an informtion carrier

(75) Inventors: Madan Pushpakath, Singapore (SG); Godfrey Ting, Singapore (SG); Ramasubramanian Natarajan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTROINCS, N.V., EINDHOVEN (NL)

(21) Appl. No.: 10/527,111

(22) PCT Filed: Aug. 27, 2003
(86) PCT No.: PCT/IB03/03836

§ 371 Date: Mar. 8, 2005

(30) Foreign Application Priority Data
Sep. 11, 2002 (EP) 02292224.9

(51) Int. Cl. G11B 33/02

(52) U.S. Cl. 720/600

(57) ABSTRACT

The invention relates to an apparatus for reading or writing information on a circular information carrier (D) having a periphery, said apparatus comprising a turntable (501) for clamping and rotating said information carrier (D), said information carrier (D) having an initial tilt from the radial direction of the turntable. The apparatus comprises additional means for applying an end load at the periphery of said information carrier, so as to apply a tilt of known value to said information carrier with respect to the radial direction of the turntable (501), said known value being larger than said initial tilt. The clamping surface of the turntable (501) may be tilted appropriately.

### FIELD OF THE INVENTION

The invention relates to an apparatus for reading or writing information on a circular information carrier having a periphery, said apparatus comprising a turntable for clamping and rotating said information carrier, said information carrier having an initial tilt from the radial direction of the turntable.

The invention may be used in the field of optical discs.

### BACKGROUND OF THE INVENTION

A lot commercially available information carriers (for example audio CD, RW discs and DVD optical discs) show distortions and deformations in radial and tangential directions. Such defaults are mainly caused by the moulding process of optical discs that is not perfect, for example uneven cooling.

A common characteristic exhibited by these discs is a tilt in the radial direction the value of which can be more or less important. The tilt causes the optical signals to deteriorate and increases jitter, leading to errors during reading or writing processes of the optical discs, especially with discs having an important tilt value.

To handle this problem, apparatus implementing known mechanisms for correcting the tilt of optical discs have been developed. In particular, a known solution consists in using actuators with 3 degrees of freedom that are servo-controlled. However, solutions based on such an active correction are expensive.

### OBJECT AND SUMMARY OF THE INVENTION

It is an object of the invention to propose a cost-effective apparatus which is capable of overcoming the tilt diversity of information carriers, and of making the reading and writing processes easier for such information carriers.

To this end, the apparatus according to the invention is characterized in that it comprises additional means for applying an end load to the periphery of said information carrier, so as to apply a tilt of known value to said information carrier with respect to the radial direction of the turntable, said known value being larger than said initial tilt.

Said additional means comprise a cover having a circular ring intended to be in contact with the periphery of said information carrier when the cover is supported and clamped in said turntable.

Irrespective of whether the information carrier has a concave or a convex tilt, and whatever the value of the initial tilt of the information carrier, the tilt of the information carrier is forced to a known value in order to adapt the optical system to this known value. Bidirectional tilt of information carriers can thus be compensated and forced to a known value.

In a preferred embodiment, the apparatus is characterized in that said additional means comprise a cover having a circular ring intended to be in contact with the periphery of said information carrier when the cover is clamped in said turntable.

In another preferred embodiment, the apparatus is characterized in that said additional means comprise a circular ring interdependent with said turntable, the circular ring being intended to be in contact with the periphery of the information carrier when said information carrier is clamped in said turntable.

In another preferred embodiment, the apparatus is characterized in that said additional means comprise a wheel rotating freely around a shaft interdependent with said apparatus, said wheel being intended to be in contact with the periphery of said information carrier when said information carrier is clamped in said turntable.

In another preferred embodiment, the apparatus is characterized in that it comprises:
an optical pick-up unit intended to move along a guide shaft, said guide shaft being parallel to the radial direction of the turntable,
an actuator fixed on said optical pick-up unit and centred on an optical axis, said optical axis being perpendicular to the radial direction of said information carrier.

In another preferred embodiment, the apparatus is characterized in that it comprises:
an optical pick-up unit intended to move along a guide shaft, said guide shaft being parallel to the radial direction of said information carrier,
an actuator fixed on said optical pick-up unit and centred on an optical axis, said optical axis being perpendicular to the radial direction of said information carrier.

When the tilt is forced to a known value, the shape of the information carrier along its radial direction is very close to a line enclosing a known angle with the radial direction of the turntable. The servo-control of the optical unit position then is easier if it is translated along this axis, leading to a cost-effective solution.

In a preferred embodiment, the apparatus is characterized in that the turntable comprises an area for supporting said information carrier, said surface being tilted to said known value in the radial direction.

This feature allows improving the tilt linearity of the information carrier along its radial direction.

Detailed explanations and other aspects of the invention will be given below.

### BRIEF DESCRIPTION OF THE DRAWING

Particular aspects of the invention will now be explained with reference to the embodiments described hereinafter and considered in connection with the accompanying drawings, in which identical parts or sub-steps are designated in the same manner:

FIG. 1 depicts a first embodiment of an apparatus according to the invention comprising means for forcing the tilt of an information carrier,

FIG. 2 depicts a second embodiment of an apparatus comprising means according to the invention for forcing the tilt of an information carrier,

FIG. 3 depicts a third embodiment of an apparatus comprising means according to the invention for forcing the tilt of an information carrier,

FIG. 4 depicts a fourth embodiment of an apparatus comprising means according to the invention for forcing the tilt of an information carrier,

FIG. 5 depicts a fifth embodiment of an apparatus comprising means according to the invention for forcing the tilt of an information carrier as described in FIG. 1 and FIG. 3,

FIG. 6 depicts a sixth embodiment of an apparatus according to the invention comprising means for reading or writing on an information carrier, the tilt being forced by means according to the invention,

FIG. 7 depicts a seventh embodiment of an apparatus according to the invention comprising means for reading or writing on an information carrier, the tilt being forced by means according to the invention,

FIG. 8 shows a three-dimensional view of means according to the invention for forcing the tilt of an information carrier.

### DETAILED DESCRIPTION OF THE INVENTION

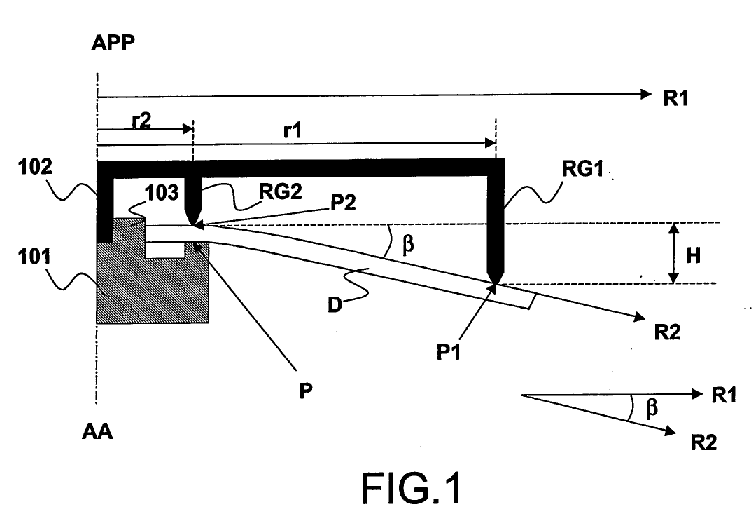

FIG. 1 depicts a first embodiment of an apparatus APP according to the invention comprising means for forcing the tilt of an information carrier D.

To facilitate the understanding of this figure and the following, only half of each element situated to the right of axis AA has been represented because of a circular symmetry around axis AA.

This apparatus comprises a turntable 101 for supporting, clamping and rotating an information carrier D around axis AA. The turntable 101 has a cylindrical shape and the radial direction R1 of said turntable is perpendicular to axis AA.

The information carrier D has a circular periphery and corresponds for example to an optical disc. The information carrier is intended to be clamped in said turntable, for example clamped or fitted in force on shaft 103. The turntable comprises a support area P for supporting the inner area of the information carrier.

The apparatus comprises a cover 102, centred on axis AA, intended to be fitted into the turntable 101, for example by means of a magnet fitted onto the turntable so as to attract the cover having a guiding pin into a locating hole and hole pin. The cover 102 then is interdependent with the turntable 101, which itself is interdependent with the information carrier D when the latter is clamped.

The side face of the cover is provided with a circular ring RG1 at a distance r1 from axis AA, which circular ring RG1 is either integral with or fixed to said side face, said cover being intended to be in contact with the outer periphery P1 of the information carrier D when the cover is clamped in the turntable. The cover being made of a stiff material so that, when it is clamped in the turntable, the ring RG1 applies a vertical end load to the periphery P1 of said information carrier, thereby forcing the tilt of said information carrier to a known value. The slope of the information carrier in its radial direction R2 is quasi-linear between the support area P and the point P1.

The known value of the tilt depends on the bias value H corresponding to the difference in height between a point P2 on top of the inner information carrier surface and the point P1. The radial direction R1 of the turntable and the radial direction R2 of the information carrier form a mean angle β.

Mean angle β can be approximated by its tangent expressed as the ratio H/(r1−r2). The mean angle β can also be known from simulations or experiments, the mean angle β corresponding to the mean slope of the tilt of the information carrier in relation to radial direction R1.

The range of the bias value H defining the tilt is generally set to a few tens of millimetres, i.e. to a value higher then the largest initial tilt value of information carriers that can be found on the market. Then, irrespective of whether the initial tilt value of the information carrier (even null), and whatever this initial tilt is concave or convex, the tilt of the information carrier is forced to said known value when the information carrier is clamped in the apparatus according to the invention.

Additionally, the cover 102 comprises a circular ring RG2, either fixed to or integral with the cover, at a distance r2 from axis AA, for exerting pressure at point P2 on the information carrier situated on the support area P of the turntable. Pressing the information carrier prevents the information carrier from slipping when it is being rotated.

According to this embodiment, the tilt of the information carrier is concave (i.e. “n shape”), which implies that the optical system for reading or writing information on the information carrier is situated under the information carrier.

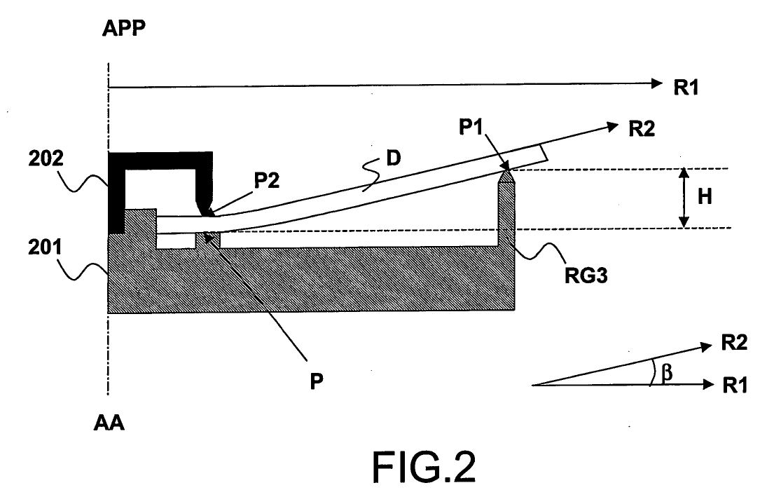

FIG. 2 depicts a second embodiment of an apparatus APP comprising means according to the invention for forcing the tilt of an information carrier D.

The means used for forcing the tilt of the information carrier comprise a circular ring RG3 interdependent with the turntable 201, the circular ring being intended to be in contact with the periphery P1 of the information carrier when said information carrier is clamped in said turntable. The information carrier D is clamped in the turntable 201 similarly as in FIG. 1.

The apparatus comprises a clamping device 202 force-fitted in the turntable 201 so as to exert pressure at point P2 on the information carrier situated on the support area P of the turntable. Pressing the information carrier at point P2 on the support area P limits the non-linear deformation of the information carrier in this area, and also prevents the information carrier from slipping in relation to the turntable during rotation.

According to this embodiment, the tilt of the information carrier is convex (i.e. “u shape”), which implies that the optical system for reading or writing information on the information carrier is situated above the information carrier.

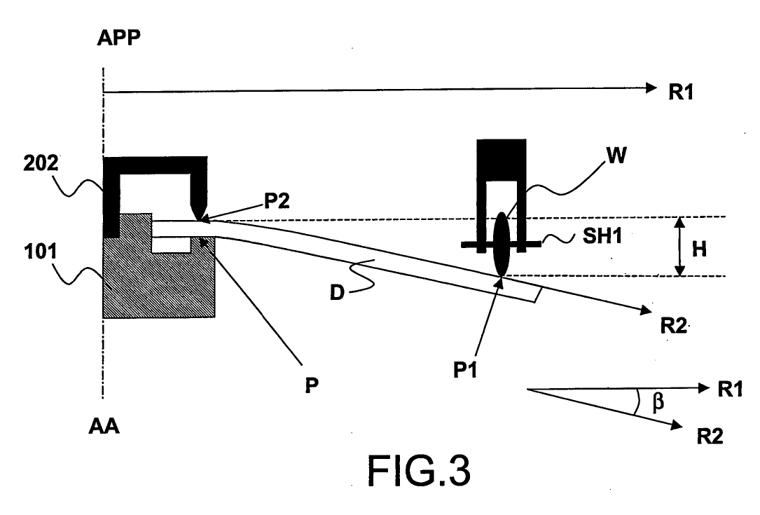

FIG. 3 depicts a third embodiment of an apparatus APP comprising means according to the invention for forcing the tilt of an information carrier D.

The means used for forcing the tilt of the information carrier comprise a wheel W rotating freely around a shaft SH1 interdependent with said apparatus, said wheel being intended to be in contact with the periphery P1 of said information carrier when said information carrier is clamped in said turntable. Contrary to embodiments depicted in FIG. 1 and FIG. 2 where the end load is applied at the same instant all along the outer periphery of the information carrier, in this case the end load is applied at a given instant only at one point of the periphery of the information carrier. The tilt of the information carrier is then forced at a known value only in the radial direction that crosses the point P1.

According to this embodiment, the tilt of the information carrier is concave (i.e. “n shape”), which implies that the optical system for reading or writing information on the information carrier is situated under the information carrier.

Of course, the wheel W and shaft SH1 can also be fixed to the apparatus symmetrically to radial direction R1 so that the tilt of the information carrier becomes convex.

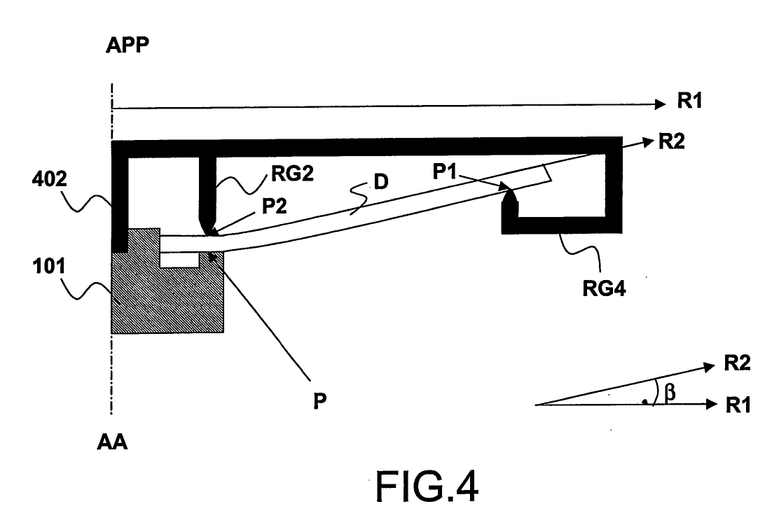

FIG. 4 depicts a fourth embodiment of an apparatus APP comprising means according to the invention for forcing the tilt of an information carrier D.

This embodiment differs from the embodiment depicted in FIG. 1 in that the cover 402 comprises a curved ring RG4 for applying a vertical end load to the periphery P1 of said information carrier.

According to this embodiment, the tilt of the information carrier is convex (i.e. “u shape”), which implies that the optical system for reading or writing information on the information carrier is situated under the information carrier.

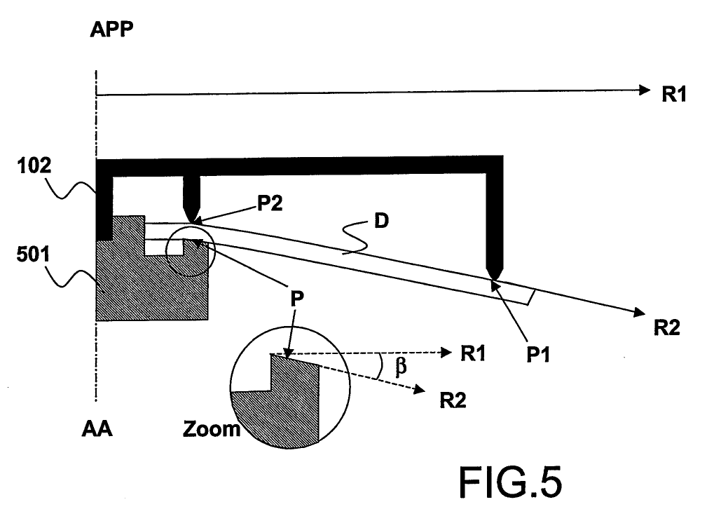

FIG. 5 depicts a fifth embodiment of an apparatus APP comprising means according to the invention for forcing the tilt of an information carrier D as described in FIG. 1 and FIG. 3.

For improving the linearity of the tilt of the information carrier in the radial direction R2 when said information carrier is clamped in the turntable 501, in particular for improving the linearity in the support area P corresponding to a flexion area, the support area P of the turntable 501 is tilted to the same value as the tilt of the information carrier. As shown in the zoom of the turntable 501, the slope of the support area P is then tilted with mean angle β.

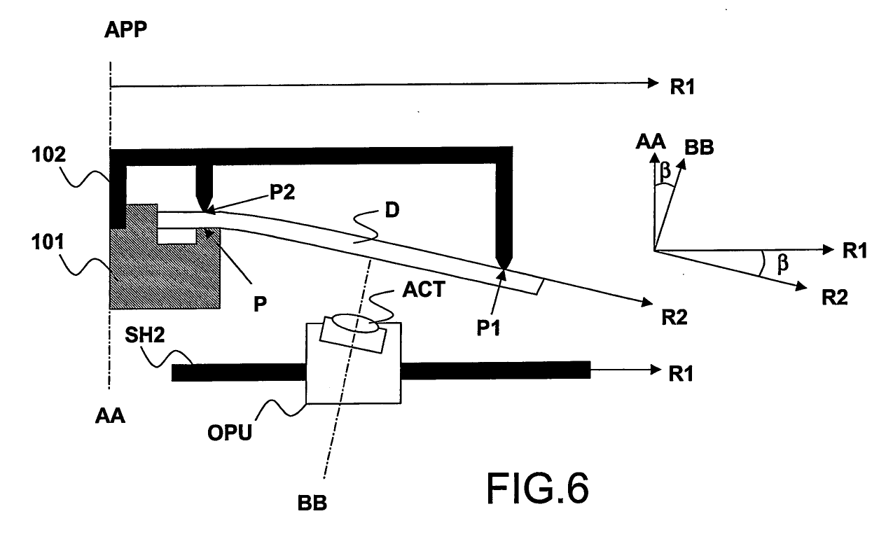

FIG. 6 depicts a sixth embodiment of an apparatus APP according to the invention comprising means for reading or writing on an information carrier D, the tilt being forced by means according to the invention.

This apparatus comprises an optical pick-up unit OPU intended to move along a guide shaft SH2, said guide shaft being parallel to the radial direction R1 of the turntable 101.

This apparatus also comprises an actuator ACT fixed on said optical pick-up unit OPU, said actuator comprising optical means such as a lens for reading or writing data on the information carrier D. The actuator is centred on an optical axis BB, said optical axis BB being perpendicular to the radial direction R2 of said information carrier. In other words, the optical axis BB is tilted over the mean angle β from axis AA.

When the optical pick-up unit translates along shaft SH2, the optical axis BB of the actuator remains perpendicular to the information carrier, which facilitates the positioning of the actuator.

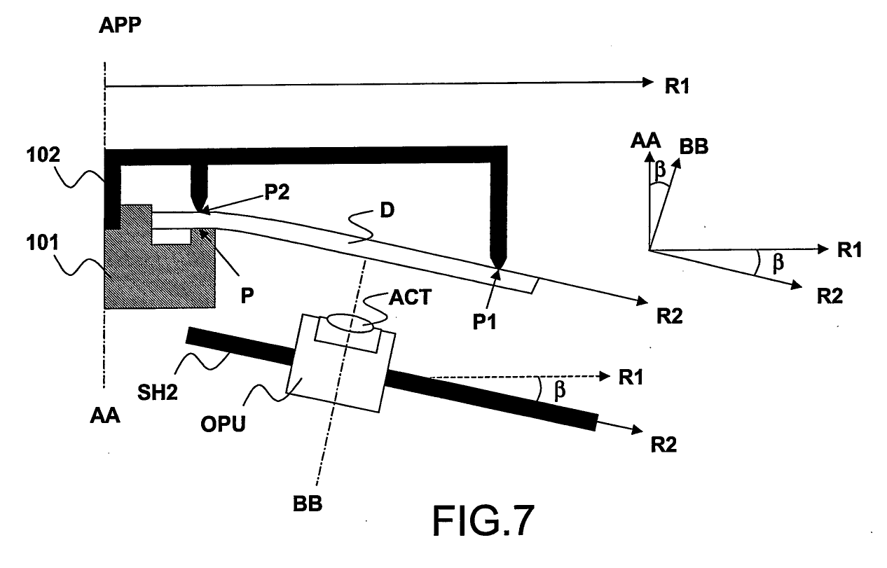

FIG. 7 depicts a seventh embodiment of an apparatus APP according to the invention comprising means for reading or writing on an information carrier D, the tilt being forced by means according to the invention.

This apparatus comprises an optical pick-up unit OPU intended to move along a guide shaft SH2, said guide shaft being parallel to the radial direction R2 of the information carrier D.

This apparatus also comprises an actuator ACT fixed on said optical pick-up unit OPU, said actuator comprising optical means such as a lens for reading or writing data on the information carrier D. The actuator is centred on an optical axis BB, said optical axis BB being perpendicular to the radial direction R2 of said information carrier. In other words, the optical axis BB is tilted over the mean angle β from axis AA.

When the optical pick-up unit translates along shaft SH2, the optical axis BB of the actuator remains perpendicular to the information carrier, which facilitates the positioning of the actuator.

Means for reading or writing on an information carrier D as depicted in FIGS. 6 and 7 can be used in relation with embodiments depicted in FIGS. 1, 3, 4 and 5. Of course, such means for reading or writing on an information carrier D, if placed symmetrically to the radial direction R1, can also be used the in embodiment depicted in FIG. 2.

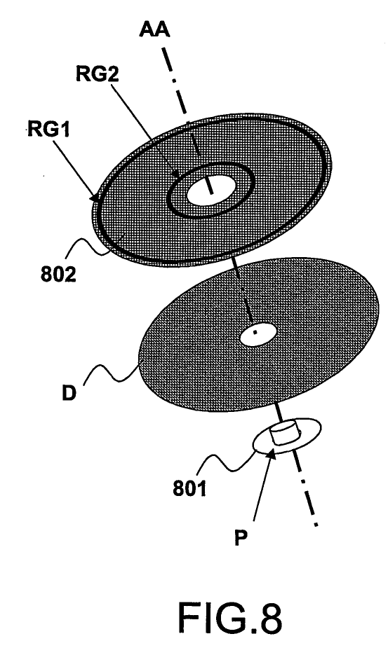

FIG. 8 shows a three-dimensional view of means according to the invention for forcing the tilt of an information carrier D.

Such means, which are symmetric around axis AA, comprise in particular turntable 801, support area P, cover 802, information carrier D, ring RG1 and ring RG2.

The apparatus according to the invention may be used in optical systems for reading and/or writing information on information carriers conforming to audio/video, CD/DVD, reading, recording or rewriting optical discs.

1. Apparatus for reading/writing information on a circular information carrier (D) having an inner area and an outer area, said apparatus comprising:
a turntable (101) for supporting and rotating said information carrier (D),
additional means for applying an end load on said outer area for setting a height difference (H) between said inner area and said outer area.

2. Apparatus as claimed in claim 1 wherein said additional means comprise a cover (102) intended to be clamped in said turntable (101), said cover (102) having a circular ring (RG1) intended to be in contact with said outer area, said contact defining a contact point (P1) projecting below said inner area.

3. Apparatus as claimed in claim 1 wherein said additional means comprise a circular ring (RG3) interdependent with said turntable (101), said circular ring (RG3) being intended to be in contact with said outer area, said contact defining a contact point (P1) projecting above said inner area.

4. Apparatus as claimed in claim 1 wherein said additional means comprise a wheel (W) rotating freely around a shaft (SH1) interdependent with said apparatus, said wheel (W) being intended to be in contact with said outer area, said contact defining a contact point (P1) projecting below or above said inner area.

5. Apparatus as claimed in claims 2, 3 or 4 wherein said apparatus comprises:
an optical pick-up unit (OPU) intended to move along a guide shaft (SH2), said guide shaft (SH2) being parallel to the radial direction (R1) of the turntable (101),
an actuator (ACT) fixed on said optical pick-up unit (OPU) and being centred on an optical axis (BB), said optical axis (13B) being perpendicular to the radial direction (R2) of said information carrier (D).

6. Apparatus as claimed in claims 2, 3 or 4 wherein said apparatus comprises:
an optical pick-up unit (OPU) intended to move along a guide shaft (SH2), said guide shaft (SH2) being parallel to the radial direction (R2) of said information carrier (D),
an actuator (ACT) fixed on said optical pick-up unit (OPU) and being centred on an optical axis (BB), said optical axis (BB) being perpendicular to the radial direction (R2) of said information carrier (D).

7. Apparatus as claimed in claim 2 or 4 wherein the turntable (101) comprises a tilted inner surface (P) for supporting said information carrier (D).
